(19) United States
(12) Patent Application Publication
(10) Pub. No.: US 2008/0254335 A1
(43) Pub. Date: Oct. 16, 2008

(54) Porous bi-tubular solid state electrochemical device

(75) Inventors: Paul T. Torgerson, Oliver Springs, TN (US); Richard Dunstan, Redmond, WA (US); Mark C. Williams, Morgantown, WV (US)

Correspondence Address: Robert M. Poteat P.C., 1092 West Outer Drive, Oak Ridge, TN, 37830, US

(73) Assignee: Worldwide Energy, Inc.

(21) Appl. No.: 12/082,320

(22) Filed: Apr. 10, 2008

Related U.S. Application Data
(60) Provisional application No. 60/923,590, filed on Apr. 16, 2007.

(51) Int. Cl. H01M 8/10; C25B 9/06

(52) U.S. Cl. 429/31; 204/242

(57) ABSTRACT

A low cost, robust bi-tubular solid state electrochemical device including a first porous, sintered support tube of a non-noble transition metal, a non-noble transition metal alloy and a cermet incorporating one or more of a non-noble transition metal and a non-noble transition metal alloy and having successive layers of a first porous electrode, a dense electrolyte and a second porous electrode, said successive layers disposed radially on the interior surface of said first porous, sintered support tube or disposed radially on the exterior surface of the first porous, sintered support tube and a second porous, sintered tubular member of a non-noble transition metal, a non-noble transition metal alloy and a cermet incorporating one or more of a non-noble transition metal and a non-noble transition metal alloy formed, deposited, or placed in electrical contact with the second porous electrode. The bi-tubular device of the present invention may comprise a solid oxide fuel cell or a solid oxide electrolyzer cell.

### CROSS REFERENCE TO RELATED APPLICATIONS

This application claims priority from U.S. Provisional Application Ser. No. 60/923,590, entitled “Porous Bi-Tubular Solid State Electrochemical Device,” filed Apr. 16, 2007, the contents of which are hereby incorporated by reference in their entirety.

### FIELD OF THE INVENTION

The present invention relates to solid state electrochemical devices and more particularly to porous tubular metal-supported solid oxide fuel cells and fuel stacks made there from. The present invention also relates to porous tubular metal-supported solid oxide electrolyzer cells.

### BACKGROUND OF INVENTION

A fuel cell is a solid state electrochemical device that converts the chemical energy in fuels (such as hydrogen, methane, butane, or even gasoline and diesel) into electrical energy by exploiting the natural tendency of oxygen and hydrogen to react. By controlling the means by which such a reaction occurs and directing the reaction through a device, it is possible to harvest the energy given off by the reaction. Fuel cells forego the traditional fuel-to-electricity production route common in modern power production, which consists of heat extraction from fuel, conversion of heat to mechanical energy and finally, transformation of mechanical energy into electrical energy. In a fuel cell, water and heat are the only byproducts while chemical energy is converted into electricity. Pollutant emissions are practically zero.

The design of a fuel cell is well known and generally comprises a porous anode electrode and a porous cathode which are separated by a dense and gas-tight electrolyte. In operation, air flows along the cathode, which is known as the “air electrode.” When an oxygen molecule contacts the cathode/electrode interface, it catalytically acquires four electrons from the cathode and splits into two oxygen ions. The oxygen ions diffuse into the electrolyte material and migrate to the other side of the cell where they encounter the anode, which is called the “fuel electrode.” The oxygen ions encounter the fuel at the anode/electrolyte interface and react catalytically, giving off water, carbon dioxide, heat, and electrons. The electrons transport through the anode to the external circuit and back to the cathode, providing a source of useful electrical power in an external circuit.

Solid oxide fuel cells (SOFCs), one type of fuel cells, are high-temperature power generation solid state devices that produce power through electrochemical reactions of the fuel (methane or hydrogen gas, for example) and oxidant (air or oxygen gas) at the anode and cathode, respectively, of the fuel cell. Advantages of solid oxide fuel cells are high efficiency (up to perhaps 60% of the chemical energy of the fuel is converted to electricity) and, because of the high temperature of operation, the ability to be integrated into a combined-cycle, or hybrid, configuration in which electrochemical cycles are combined with Brayton and/or Rankine cycles to maximize power production, use of fuel, and efficiency.

SOFC technology offers the highest potential of all fuel cell technologies for long-term application to the vast majority of potential stationary residential, commercial, and industrial markets that operate at relatively high temperatures, such as 800-1000° C., for distributed generation (DG) applications. Operating SOFCs at such high temperatures beneficially allows for internal reforming of methane and produces high-quality process

Solid oxide fuel cell elements are generally one of two basic designs: (1) planar where individual fuel cell elements are flat sandwiched layers of various materials comprising anode, electrolyte and cathode and (2) tubular. Planar SOFC devices are theoretically more efficient than tubular devices but are generally recognized as having significant safety and reliability issues due to the complexity of sealing and manifolding a planar stack. Tubular SOFC devices are generally believed to be more easily implemented than planar but tubular designs provide less power density than planar devices due to their relatively long current path that result in substantial resistive power loss.

Further, fuel cell designs in general and SOFCs in particular requires a structure that derives mechanical support from either the electrolyte layer or from one of the electrode layers. Each of these designs has disadvantages in providing acceptable fuel cells, such as SOFCs, which are low-cost, reliable, devices having excellent structural stability at high temperatures, e.g., 800° C. and overcome the start-up and load-following problems related to material failures caused by severe thermal cycling of the prior art designs.

U.S. Pat. No. 5,827,620 describes a tubular electrolyte-supported fuel cell. These fuel cells require a thick electrolyte layer sufficient to mechanically support the fuel cell. Consequently, these fuel cells have higher resistance and are slower to start. They also are more expensive to manufacture

U.S. Pat. No. 5,908,713 to Ruka et al describes a cathode-supported SOFC. Cathode-supported SOFC are typically expensive to manufacture and suffers from high ohmic loses due to long current path along the circumference of the cathode tube.

Published U.S. patent application US 2002/0028367 A1 describes a tubular anode-supported SOFC. The electrical connections among anode-supported fuel cells are more difficult. In the anode-supported structure, the electrical connectors are required to be both oxidation resistant in the airflow at high temperatures and flexible to maintain good electrical contacts with the tubular cells over the thermal cycles through low and high temperatures.

It is known in the art that solid oxide fuel cells can be operated in the electrolysis mode (i.e., a Solid Oxide Electrolysis Cell or SOEC), consuming electrical power and process heat while producing hydrogen.

One objective of the present invention is to provide a robust and rugged metal tubular solid state electrochemical device that has excellent structural stability at high temperatures, e.g., 800° C.

Another object of the present invention is to provide a metal tubular solid state electrochemical device that overcomes the primary barriers to effective application of current solid state electrochemical devices due to start-up and load-following problems related to material failures caused by severe thermal cycling of the prior art designs.

Still another object of the present invention is to provide a metal tubular solid state electrochemical device that has greatly reduced material fabrication and manufacturing costs.

A further object of the present invention is to provide a metal tubular solid state electrochemical device that has improved oxidation resistance at high operating temperatures.

Still a further object of the present invention is to provide a metal tubular solid state electrochemical device that solves inadequate current collection designs of prior solid state electrochemical devices.

Accordingly, a need in the art exists for a rugged and robust metal tubular solid state electrochemical device that has excellent thermal stability, low fabrication and manufacture cost, and improved current collection designs.

### SUMMARY OF THE INVENTION

To achieve the foregoing and other objects, and in accordance with the present invention as embodied and broadly described herein, the present invention is a bi-tubular solid state electrochemical device comprising a first porous, sintered support tube consisting essentially of a material selected from the group consisting of a non-noble transition metal, a non-noble transition metal alloy and a cermet incorporating one or more of a non-noble transition metal and a non-noble transition metal alloy and having successive layers of a first porous electrode, a dense electrolyte and a second porous electrode, said successive layers disposed radially on the interior surface of said first porous, sintered support tube, and a second porous sintered tubular member consisting essentially of a material selected from the group consisting of a non-noble transition metal, a non-noble transition metal alloy and a cermet incorporating one or more of a non-noble transition metal and a non-noble transition metal alloy formed, deposited, or placed in electrical contact with said second porous electrode.

In another embodiment of the present invention there is provided a bi-tubular solid oxide electrochemical device comprising a first porous, sintered support tube consisting essentially of a material selected from the group consisting of a non-noble transition metal, a non-noble transition metal alloy and a cermet incorporating one or more of a non-noble transition metal and a non-noble transition metal alloy and having successive layers of a first porous electrode, a dense electrolyte and a second porous electrode, said successive layers disposed radially on the exterior surface of said first porous, sintered support tube, and a second porous, sintered tubular member consisting essentially of a material selected from the group consisting of a non-noble transition metal, a non-noble transition metal alloy and a cermet incorporating one or more of a non-noble transition metal and a non-noble transition metal alloy formed, deposited, or placed in electrical contact with said second porous electrode.

In a further refinement of the bi-tubular solid state electrochemical device of the present invention, the successive layers may comprise a first porous anode layer, which is disposed radially on the interior surface of the first porous, sintered support tube, or disposed radially on the exterior surface of the first porous, sintered support tube, followed successively, by a dense electrolyte layer, and then a second porous cathode layer.

In an alternate refinement of the bi-tubular solid state electrochemical device of the present invention, the successive layers may be reversed, i.e., a first porous cathode layer disposed radially on the interior surface of the first porous, sintered support tube, or disposed radially on the exterior surface of the first porous, sintered support tube, followed by, successively, a dense electrolyte layer and then a second porous anode layer.

In each of these refinements, a second porous, sintered tubular member consisting essentially of a material selected from the group consisting of a non-noble transition metal, a non-noble transition metal alloy and a cermet incorporating one or more of a non-noble transition metal and a non-noble transition metal alloy is formed, deposited, or placed in electrical contact with the second porous cathode layer or second porous anode layer to complete the bi-tubular solid state electrochemical device of the present invention.

In a further related embodiment of the present invention there is provided a bi-tubular solid oxide fuel cell comprising a first porous, sintered support tube consisting essentially of a material selected from the group consisting of a non-noble transition metal, a non-noble transition metal alloy and a cermet incorporating one or more of a non-noble transition metal and a non-noble transition metal alloy having successive layers of a first porous electrode, a dense electrolyte and a second porous electrode, said successive layers disposed radially on the interior surface of said first porous, sintered support tube, and a second porous, sintered tubular member consisting essentially of a material selected from the group consisting of a non-noble transition metal, a non-noble transition metal alloy and a cermet incorporating one or more of a non-noble transition metal and a non-noble transition metal alloy formed, deposited, or placed in electrical contact with said second porous electrode.

In still another related embodiment of the present invention there is provided a bi-tubular solid oxide fuel cell comprising a first porous, sintered support tube consisting essentially of a material selected from the group consisting of a non-noble transition metal, a non-noble transition metal alloy and a cermet incorporating one or more of a non-noble transition metal and a non-noble transition metal alloy and having successive layers of a first porous electrode, a dense electrolyte and a second porous electrode, said successive layers disposed radially on the exterior surface of said first porous, sintered support tube, and a second porous, sintered tubular member consisting essentially of a material selected from the group consisting of a non-noble transition metal, a non-noble transition metal alloy and a cermet incorporating one or more of a non-noble transition metal and a non-noble transition metal alloy formed, deposited, or placed in electrical contact with said second porous electrode.

In a further refinement of the bi-tubular solid oxide fuel cell of the present invention, the successive layers may comprise a first porous anode layer, which is disposed radially on the interior surface of the first porous, sintered support tube, or disposed radially on the exterior surface of the first porous, sintered support tube, followed successively, by a dense electrolyte layer, and then a second porous cathode layer.

Further, in an alternate refinement of the bi-tubular solid oxide fuel cell of the present invention, the successive layers may be reversed, i.e., a first porous cathode layer disposed radially on the interior surface of the first porous, sintered support tube, or disposed radially on the exterior surface of the first porous, sintered support tube, followed by, successively, a dense electrolyte layer and then a second porous anode layer.

In each of these refinements of the bi-tubular solid oxide fuel cell, a second porous, sintered tubular member consisting essentially of a material selected from the group consisting of a non-noble transition metal, a non-noble transition metal alloy and a cermet incorporating one or more of a non-noble transition metal and a non-noble transition metal alloy is formed, deposited, or placed in electrical contact with the second porous cathode layer or second porous anode layer to complete the bi-tubular solid state electrochemical device of the present invention.

When operated as a solid oxide fuel cell in this embodiment and more particularly in a preferred embodiment of the present invention, where the first porous electrode is an anode, fuel, such as hydrogen, would flow along the outside of the outer porous, sintered support tube and air as the oxidant would flow along the inside of the second inner, porous, sintered tubular member. Alternately, when operated as a solid oxide fuel cell in this embodiment and more particularly where the first porous electrode is a cathode, fuel, such as hydrogen, would flow along the inside of the second inner, porous, tubular member and air as the oxidant would flow along the outside of the outer porous, sintered support tube.

Advantageously, the solid state electrochemical device of the present invention may, for example, be operated as either a solid oxide fuel cell (SOFC) or as a solid oxide electrolyzer (SOEC) cell.

Accordingly, in yet another related embodiment of the present invention there is provided a bi-tubular solid oxide electrolyzer cell comprising a first porous, sintered support tube consisting essentially of a material selected from the group consisting of a non-noble transition metal, a non-noble transition metal alloy and a cermet incorporating one or more of a non-noble transition metal and a non-noble transition metal alloy having successive layers of a first porous working electrode (anode), a dense electrolyte and a second porous cathode, said successive layers disposed radially on the interior surface of said first porous, sintered support member, and a second porous, sintered tubular member consisting essentially of a material selected from the group consisting of a non-noble transition metal, a non-noble transition metal alloy and a cermet incorporating one or more of a non-noble transition metal and a non-noble transition metal alloy is formed, deposited, or placed in electrical contact with said second porous electrode.

In still another related embodiment of the present invention there is provided a bi-tubular solid oxide electrolyzer cell comprising a first porous, sintered support tube consisting essentially of a material selected from the group consisting of a non-noble transition metal, a non-noble transition metal alloy and a cermet incorporating one or more of a non-noble transition metal and a non-noble transition metal alloy and having successive layers of a first porous working electrode (anode), a dense electrolyte and a second porous cathode, said successive layers disposed radially on the exterior surface of said first porous, sintered support tube, and a second porous, sintered tubular member consisting essentially of a material selected from the group consisting of a non-noble transition metal, a non-noble transition metal alloy and a cermet incorporating one or more of a non-noble transition metal and a non-noble transition metal alloy formed, deposited, or placed in electrical contact with said second porous electrode.

This bi-tubular configuration (i.e. a “tube-in-a tube”) of the present invention offers a number of advantages over the prior art solid electrochemical devices, such as solid oxide fuel cells. One advantage is that the present invention offers structural stability, increased strength, lower operation temperatures and a more robust design, ensuring long performance life. Moreover, the increased strength and robust design of the bi-tubular configuration of the present invention advantageously provides for fast start-up and load-following capabilities without the thermal-cycling failures experienced by other prior art devices. Additionally, the present invention overcomes the prior art problems associated with anode and cathode current collection by providing a thick continuous metallic electronic conduction pathway. Also, the SOFC of the present invention may be manufactured at significantly lower costs than the more conventional ceramic tubular or planar designs. Materials costs are reduced because metals are substituted for ceramics to support the fuel cell and thinner layers are possible with the present invention. Still in one embodiment of the present invention a further advantage may be obtained by fabricating the porous, sintered support tube out of a metal which has a protective, electronically conductive oxide layer (deposited as a coating, cladding or generated insitu) such as a Mn—Co spinel. Advantageously, this layer will protect the cathode from chrome evaporation and runaway corrosion leading to short operating lifetimes.

Other features and advantages of the invention will be set forth in, or apparent from, the following detailed description of preferred embodiments of the invention.

### BRIEF DESCRIPTION OF THE DRAWINGS

FIG. 1 shows a side view and a cross-section view of a bi-tubular solid oxide fuel cell of the present invention wherein successive inner layers comprise a first porous electrode comprising an anode, a dense electrolyte and a second porous electrode comprising a cathode are disposed radially on the interior surface of a first porous, sintered support tube, and a second porous, sintered tubular member in electrical contact with the porous cathode electrode.

FIG. 2 shows a side view and a cross-section view of a bi-tubular solid oxide fuel cell of the present invention wherein the successive inner layers comprise a first porous electrode comprising a cathode, a dense electrolyte and a second porous electrode comprising an anode are disposed radially on the interior surface of a first porous, sintered support tube, and a second porous, sintered tubular member in electrical contact with the porous anode electrode.

FIG. 3 is a schematic bi-tubular solid oxide fuel cell of the present invention wherein the successive inner layers comprise a first porous electrode comprising an anode, a dense electrolyte and a second porous electrode comprising a cathode are disposed radially on the interior surface of a first porous, sintered support tube, and a second porous, sintered tubular member in electrical contact with the porous cathode electrode in a power generation mode.

FIG. 4 is a schematic showing the preferred bi-tubular solid oxide fuel cell of the present invention wherein the successive inner layers comprise a first porous electrode comprising a cathode, a dense electrolyte and a second porous electrode comprising an anode are disposed radially on the interior surface of a first porous, sintered support tube, and a second porous, sintered tubular member in electrical contact with the porous anode electrode in a power generation mode.

FIG. 5 is a schematic showing the bi-tubular solid oxide electrolyzer cell of the present invention wherein the successive inner layers comprise a first porous electrode comprising a working electrode (anode), a dense electrolyte and a second porous cathode (+) are disposed radially on the interior surface of a first porous, sintered support tube, and a second porous, sintered metal or metal alloy tubular member in electrical contact with the porous cathode electrode in a hydrogen generation mode.

FIG. 6 shows a side view and a cross-section view of a bi-tubular solid oxide fuel cell of the present invention wherein the successive outer layers comprise a first porous electrode comprising an anode, a dense electrolyte and a second porous electrode comprising a cathode are disposed radially on the exterior surface of a first porous, sintered support tube, and a second porous, sintered tubular member in electrical contact with the porous cathode electrode.

FIG. 7 shows a side view and a cross-section view of a bi-tubular solid oxide fuel cell of the present invention wherein the successive outer layers comprise a first porous electrode comprising a cathode, a dense electrolyte and a second porous electrode comprising an anode are disposed radially on the exterior surface of a first porous, sintered support tube, and a second porous, sintered tubular member in electrical contact with the porous anode electrode.

FIG. 8 is a schematic showing a bi-tubular solid oxide fuel cell of the present invention wherein the successive outer layers comprise a first porous electrode comprising an anode, a dense electrolyte and a second porous electrode comprising a cathode are disposed radially on the exterior surface of a first porous, sintered support tube, and a second porous, sintered tubular member in electrical contact with the porous cathode electrode in a power generation mode.

FIG. 9 is a schematic showing an alternate refinement of the bi-tubular solid oxide fuel cell of the present invention wherein the successive outer layers comprise a first porous electrode comprising a cathode, a dense electrolyte and a second porous electrode comprising an anode are disposed radially on the exterior surface of a first porous, sintered support tube, and a second porous, sintered tubular member in electrical contact with the porous anode electrode in a power generation mode.

FIG. 10 is a schematic showing a bi-tubular solid oxide electrolyzer cell of the present invention wherein the successive outer layers comprise a first porous electrode comprising a working electrode (anode), a dense electrolyte and a second porous cathode (+) are disposed radially on the exterior surface of a first porous, sintered support tube, and a second porous, sintered metal or metal alloy tubular member in electrical contact with the porous cathode electrode in a hydrogen generation mode.

### DETAILED DESCRIPTION OF THE PREFERRED EMBODIMENTS

The present invention can best be described with reference to the attached drawings. The reference characters refer to the same parts throughout the various views. The drawings are not to scale and are presented to help illustrate the principles of the present invention in a clear manner. Further, the invention is drawn to a solid state electrochemical device comprising in one embodiment a solid oxide fuel cell (SOFC) which may operate in a power mode providing a source of useful electrical power to an external circuit and in another mode as a solid oxide electrolyzer cell (SOEC) which may operate by consuming electrical power and process heat while producing hydrogen.

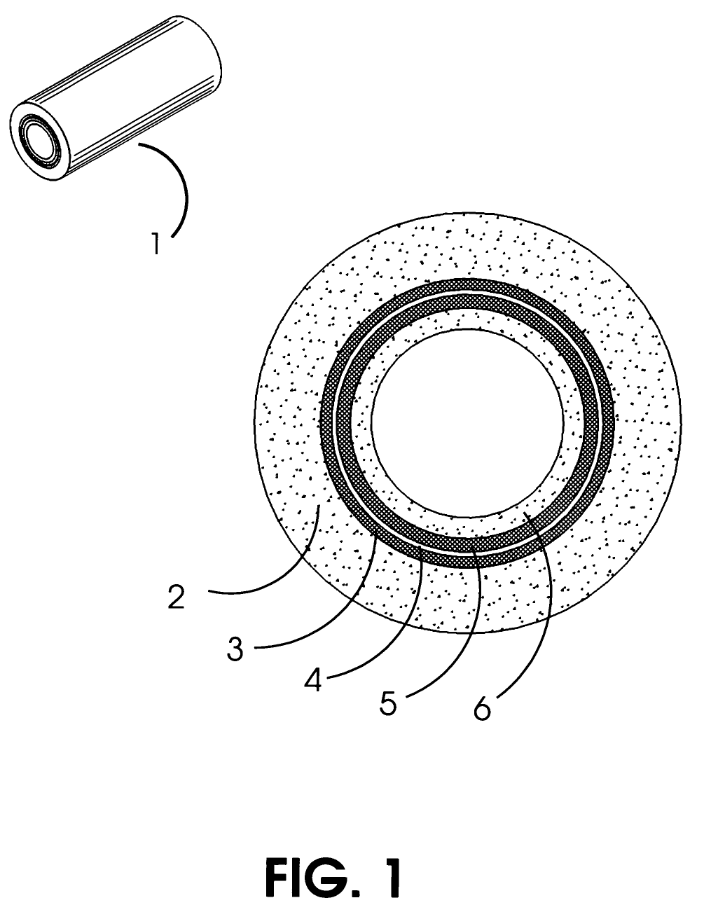

As described above and with particular reference to FIG. 1, the solid state electrochemical device of the present invention is shown as a solid oxide fuel cell 1. The solid oxide fuel cell 1 may be comprised of a first porous, sintered support tube 2 having successive layers of a first porous electrode 3, a dense electrolyte 4, and a second porous electrode 5, disposed radially on the interior surface of the first porous, sintered support tube 2 and a second porous, sintered tubular member 6 which is formed, deposited, or placed in electrical contact with the second porous electrode 5. In the preferred embodiment of the present invention, the first porous electrode is a porous anode and the second porous electrode is a porous cathode.

The support tube 2 may, for example, comprise any porous, sinterable material selected from the group consisting of a non-noble transition metal, metal alloy and a cermet incorporating one or more of a non-noble transition metal and a non-noble transition metal alloy. Suitable material for the porous support tube 2 is a Series 300 and 400 stainless steel which have a melting point in the range of 1370° C. to 1530° C., depending upon the specific composition of the steel. The preferred material is 434L stainless steel (a low carbon steel) which has a melting point of ˜1510° C. to 1530° C. Preferably the 434L stainless steel material is prepared from water-atomized 434L stainless steel powder having a particle size of 25-53 microns and preferably 38-45 microns.

It will be appreciated that in accordance with the present invention the support tube 2 and tubular member 6 each should be sinterable to a final product that has sufficient open porosity to permit oxygen, water or hydrogen to penetrate the pores of the support tube 2 and the tubular member 6. A suitable range of porosities for support tube 2 and tubular member 6 is 40%-60%, and preferably 50%-60%.

Techniques for sintering materials comprising material selected from the group consisting of a non-noble transition metal, metal alloy and a cermet incorporating one or more of a non-noble transition metal and a non-noble transition metal alloy are well know in the art.

In the present embodiment shown in FIG. 1 wherein the porous support tube 2 forms the outer tube on which the successive layers are disposed radially on its interior surface, the porous support tube 2 should preferably be pre-fired to an elevated temperature that imparts sufficient strength and robustness to the porous support tube 2 to facilitate subsequent processing steps of placing the successive layers on its interior surface but does not produce any substantial dimensional change in the porous support tube 2. Those skilled in the art will recognize this pre-firing technique as “bisque firing.” Accordingly, this pre-firing of the porous support tube 2 may be carried out at an elevated temperature, such as about 1050° C., for 2 hours in hydrogen or argon. Pre-firing the porous support tube 2 at this temperature and time provides sufficient strength and robustness to enable the placement of the successive layers on the inside of support tube 2 and still permits a final sintering at a higher elevated temperature, e.g., at 1300° C. for preferably about 2 hours in hydrogen or argon, of the assembled solid oxide fuel cell 1 after the second porous, sintered tubular member 6 is formed, deposited or placed in electrical contact with the second porous electrode 5 to complete the solid oxide fuel cell 1. The pre-firing of the porous support tube 2, when coupled with the final sintering of the solid oxide fuel cell 1 at these conditions, provide the necessary porosity to permit oxygen, water, or hydrogen to penetrate the porous support tube 2 and to ensure continuous electrical contact between the tubular member 6 and the inner most electrode 5 along the length of the solid oxide fuel cell 1.

The support tube 2 may be made by conventional powder metallurgy techniques, such as molding, casting, extrusion, compression, hot-pressing, isostatic compression, etc.

The support tube 2 may be of varying diameters and preferably has a diameter of between 11-38 mm with a wall thickness of 500 μm to 1000 μm.

Turning again to FIG. 1, a layer of a first porous anode 3 is placed on the interior surface of the first porous support tube 2. Anode materials may comprise nickel oxide (NiO) and yttria-stabilized zirconia (YSZ) or nickel oxide (NiO) and ceria (CeO₂) or doped ceria, ceria or other suitable rare earth combined with a precious metal (such as silver). Preferably the porous anode 3 is a conventional Ni-yttria-stabilized zirconia (YSZ) having a thickness of from 5 μm to 50 μm and preferably from 5 μm to 20 μm. For this step, any one of several conventional ceramic processing techniques may be used to place the anode on the interior surface of the porous sintered support tube 2. These processing techniques may include, for example, wash-coating of an aqueous or non-aqueous slurry prepared by mixing powders of the nickel oxide and yttria-stabilized zirconia with, for example, water and spraying the aqueous slurry on the inside surface of the porous, sintered support tube 2. These methods have been shown to cause no undesirable reaction between the anode 3 and the electrolyte 4. This coating application step may be carried out at room temperature. The coated support tube 2 may then be dried in air at 100° C.

Next an electrolyte layer 4 is placed on the first porous anode 3. Electrolyte materials may comprise yttria stabilized zirconia (YSZ) or other rare earth oxide stabilized zirconia, such as ceria or any other suitable ceramic oxygen ion conductor. A preferred electrolyte material is conventional yttria-stabilized zirconia (YSZ).

The electrolyte layer 4 may be deposited or coated onto the porous anode layer 3 using conventional techniques and may be wash-coated, thermal/plasma sprayed, ink printing, dip-coated, or otherwise layered onto the porous anode layer 3. For example, wash-coating may be employed for this application step by using an aqueous or non-aqueous slurry prepared by mixing powders of the yttria-stabilized zirconia with, for example, water and spraying the aqueous slurry on the anode layer 3 which has been applied to the inside surface of the porous, pre-fired support tube 2 and dried. This coating application step may be carried out at room temperature. The coated support tube 2 may then be dried in air at 100° C.

The electrolyte layer 4 may be applied to a thickness of from 2 μm to 100 μm and preferably from 2 μm to 50 μm.

A second porous electrode comprising a cathode 5 is then placed on the electrolyte 4. Suitable materials for the cathode 5 are doped and undoped oxides or mixtures of oxides in the pervoskite family such as LaMnO₃, LaNiO₃, LaCoO₃, LaCrO₃ and other electronically conducting mixed oxides generally composed of rare earth oxides mixed with oxides of cobalt, nickel, copper, iron, chromium, manganese, and combinations of such oxides. A strontium doped lanthanum manganite material may be used as the cathode material with the preferred cathode material being La₈Sr₂MnO₃.

For this step, any one of several conventional ceramic processing techniques may be used to place the cathode layer 5 on the electrolyte layer 4. These processing techniques may include in a preferred embodiment wash-coating of an aqueous or non-aqueous slurry prepared by mixing powders of the strontium doped lanthanum manganite with, for example, water and spraying the aqueous slurry on the deposited electrolyte layer 4. As with the other coating applications step, this coating application step may be carried out at room temperature, followed by drying the deposited cathode layer 5 in air at 100° C.

The cathode layer 5 may be applied to a thickness of from 10 μm to 100 μm and preferably from 10 μm to 50 μm.

At this stage of the fabrication process, a sub-assembly of the solid oxide fuel cell 1 has been prepared which consists of the pre-fired porous support tube 2 with the attached active layers of the anode layer 3, dense electrolyte 4, and cathode layer 5.

Next, a second porous tubular member 6 is formed, deposited or placed in electrical contact with cathode layer 5. Suitable materials for the porous tubular member 6 may be those selected for the first porous support tube 2 as above described. Accordingly, the porous tubular member 6 may comprise any porous, sinterable material selected form the group consisting of a non-noble transition metal, metal alloy and a cermet incorporating one or more of a non-noble transition metal and an non-noble transition metal alloy. Suitable material for the porous, tubular member 6 is a Series 300 and 400 stainless steel which have a melting point in the range of 1370° C. to 1530° C., depending upon the specific composition of the steel. The preferred material is stainless steel 434L (a low carbon steel) which has a melting point of ˜1510° C. to 1530° C. Preferably the 434L stainless steel material is prepared from water-atomized 434L stainless steel powder having a particle size of 25-53 microns and preferably 38-45 microns. Preferably the wall thickness of the porous, tubular member 6 is between 500 μm and 1000 μm. The porous tubular member 6 may be prepared by the same techniques used in preparing the first porous support tube 2.

In one aspect of the present invention and in a preferred embodiment, tubular member 6 is prepared separately and sintered at an elevated temperature, such as for example at 1300° C. preferably for about 2 hours in hydrogen or argon, prior to being placed as the inner porous tubular member 6 of the present bi-tubular design. This sintering temperature and sintering time preferably are selected to be the same as the final sintering temperature and sintering time for the assembled solid oxide fuel cell 1. In this way tubular member 6 will undergo minimal or no shrinkage during the final sintering of the assembled solid oxide fuel cell, permitting the support tube 2 which has been pre-fired to a lower temperature of about 1050° C., as discussed above, to shrink onto the tubular member 6, thus permitting a tight electrical connection between the tubular member 6 and the inner most electrode 5 along the length of the solid oxide fuel cell 1. Those skilled in the art will recognize this sintering technique to be a constrained sintering process.

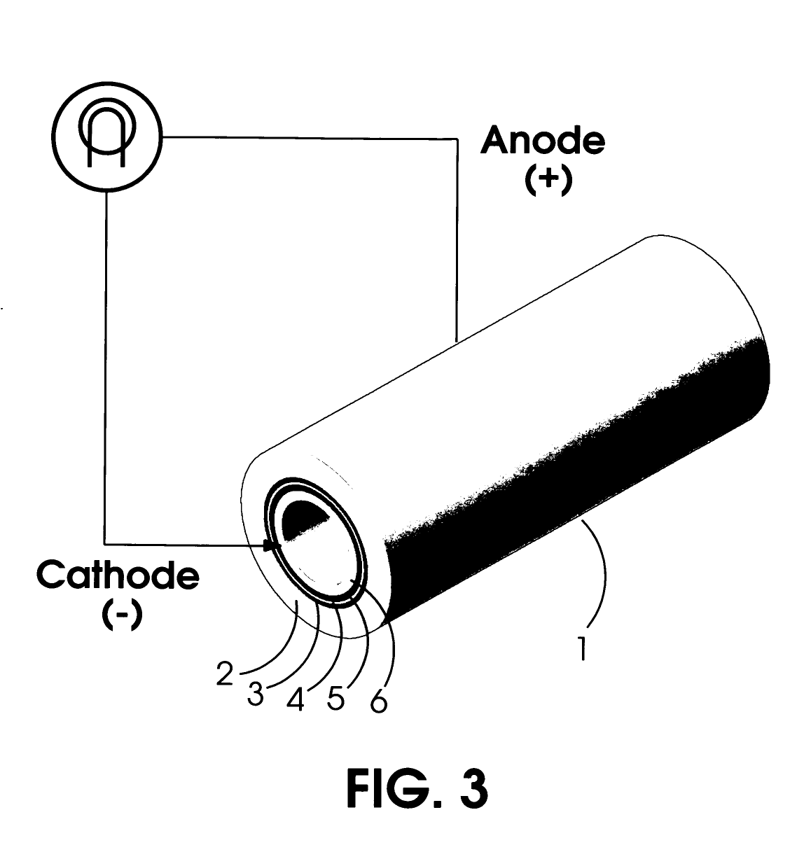

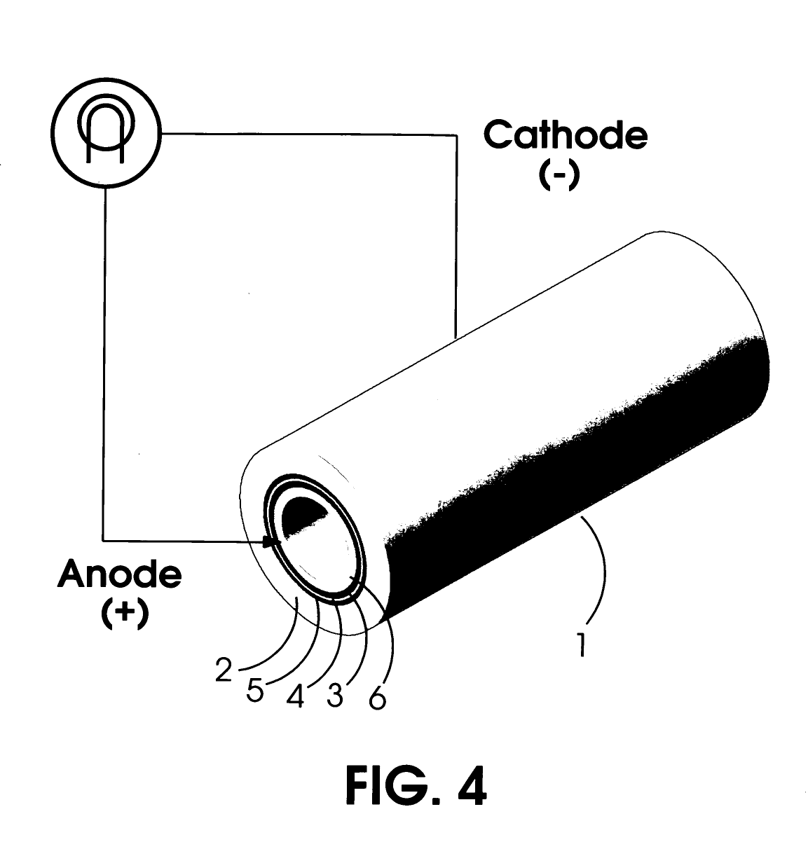

This sintering regime also ensures continuous electrical contact along the length of the finished solid oxide fuel cell 1 between porous tubular member 6 and the inner most porous electrode 5 depicted in a power generation mode shown in FIG. 3 as the cathode and in FIG. 4 as the anode.

It is important for the successful practice of the present invention that in embodiments shown in FIGS. 1-5 that the porous sintered tubular member 6 is sized properly for safe placement within the sub-assembled porous support tube 2 to prevent damage or scarring of the inner most electrode of the sub-assembled support tube 2. It is expected that a porous tubular member 6 formed using water-atomized 434L stainless steel powder having a particle size of 38-45 microns and having a wall thickness of 1000 μm will undergo a shrinkage of about 20% when sintered at 1300° C. for about 2 hours in hydrogen or argon.

Lastly, the assembled solid oxide fuel cell 1 is given a final sintering at an elevated temperature of preferably 1300° C. for about 2 hours in hydrogen or argon to form the final solid oxide fuel cell product. In this way tubular member 6 will undergo minimal or no shrinkage during the final sintering of the assembled solid oxide fuel cell 1, permitting the support tube 2 which has been pre-fired to a tower temperature of about 1050° C., as discussed above, to shrink onto the tubular member 6, thus permitting a tight electrical connection between the tubular member 6 and the inner most electrode 5 along the length of the solid oxide fuel cell 1. Further, conducting this final sintering of the assembled solid oxide fuel cell 1 at 1300° C. for about 2 hours in hydrogen or argon ensures that the final solid oxide fuel cell product has sufficient porosity to permit oxygen, water or hydrogen to penetrate the pores of sintered support tube 2 and tubular member 6.

Additionally, carrying out the final sintering of the assembly solid oxide fuel cell 1 at sintering at 1300° C. for about 2 hours in hydrogen or argon results in a porous anode layer 3, a dense electrolyte layer 4, and a porous cathode layer 5. For this, it has been found that sintering at 1300° C. preferably for 2 hours in hydrogen or argon is sufficient to produce anode and cathode layers having a porosity of preferably about 35% while providing the electrolyte layer with a density above 90% of theoretical, preferably above about 95% of theoretical.

As noted herein above, in an alternate refinement of the present invention the successive layers may be reversed, i.e., a first porous cathode layer 5 being disposed radially on the interior surface of the first porous support tube 2, followed by, successively, a dense electrolyte layer 4, and then a second porous anode layer 3.

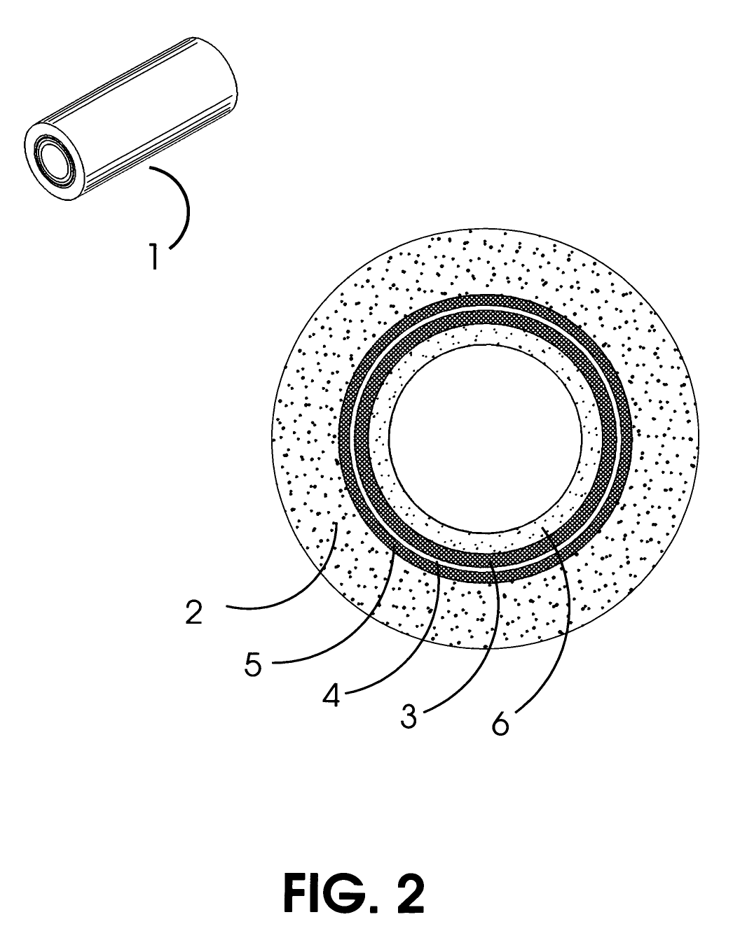

This alternate refinement of the present invention is shown in FIG. 2 where the solid state electrochemical device of the present invention is shown as a solid oxide fuel cell 1. The solid oxide fuel cell 1 may be comprised of a first porous support tube 2 having successive layers of a first porous electrode comprising a porous cathode 5, a dense electrolyte 4, and a second porous electrode comprising a porous anode 3, disposed radially on the interior surface of the first porous support tube 2 and a second porous, sintered tubular member 6 which is formed, deposited, or placed in electrical contact with the second porous anode 3.

FIG. 3 is a schematic showing the solid oxide fuel cell 1 of the present invention wherein the successive layers are disposed radially on the interior surface of the first porous support tube 2 and comprising a first porous electrode comprising an anode 3, a dense electrolyte 4 and a second porous electrode comprising a cathode 5, and a second porous sintered tubular member 6 formed, deposited, or placed in electrical contact with the inner most porous cathode electrode 5 in a power generation mode. In this mode, the electrons transport through the anode 3 to the external circuit and back to the cathode 5, providing a source of useful electrical power in an external circuit. For a SOFC operating at 800° C. a typical operating current is 325 mA/cm at 0.75 volt and power density of 250 mW/cm².

FIG. 4 is a schematic showing the preferred bi-tubular solid oxide fuel cell 1 of the present invention wherein the successive inner layers are shown being disposed radially on the interior surface of the first porous support tube 2 and comprising a first porous electrode comprising a cathode 5, a dense electrolyte 4 and a second porous electrode comprising an anode 3, and a second porous sintered tubular member 6 placed in electrical contact with the porous anode electrode 3 in a power generation mode. In this mode, the electrons transport through the anode 3 to the external circuit and back to the cathode 5, providing a source of useful electrical power in an external circuit. For a SOFC operating at 800° C. a typical operating current is 325 mA/cm² at 0.75 volt and power density of 250 mW/cm².

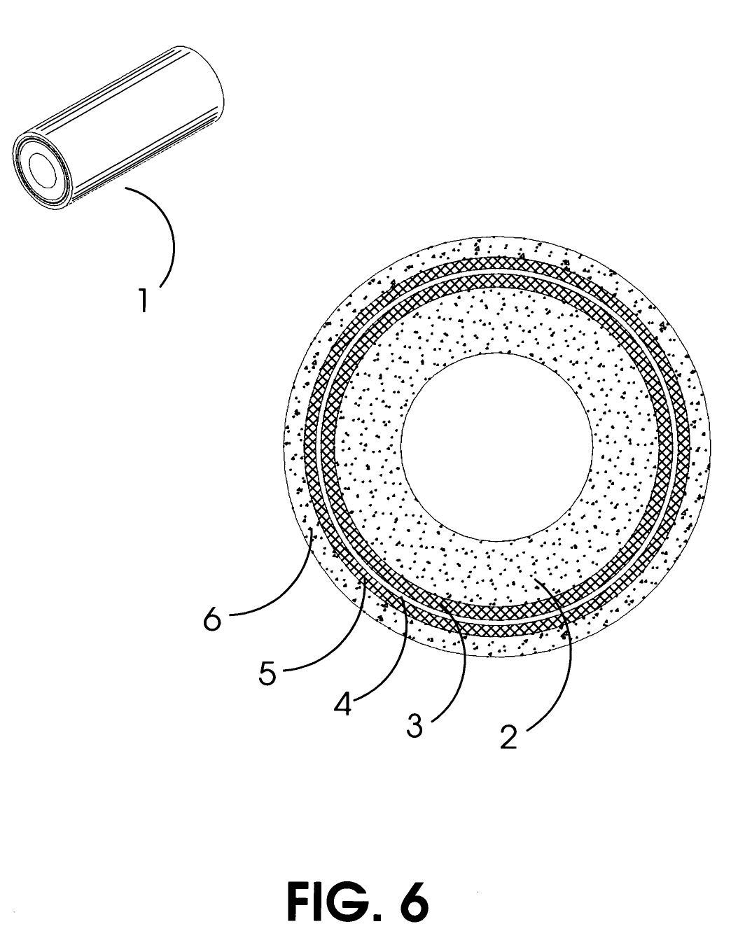

Having described bi-tubular solid oxide electrochemical device in accordance with one embodiment of the present invention wherein the active layers are successively disposed radially on the interior surface of a porous support tube with the second porous tubular member being formed, deposited, or placed in electrical contact with the inner most porous electrode, other embodiments of the present invention are depicted in FIGS. 6-9. In these embodiments the active layers are successively disposed radially on the exterior surface of a first porous support tube 2 with the second porous tubular member 6 being formed, deposited, or placed in electrical contact with the outer most porous electrode 5.

It will be appreciated that the solid oxide fuel cell for this external design may be prepared by the same techniques used in preparing the solid oxide fuel cell for the internal design as described with particular reference to FIGS. 1-5. In particular the porous support tube 2 should be pre-fired to an elevated temperature that imparts sufficient strength and robustness to the porous support tube 2 to facilitate subsequent process steps of placing the successive layers of the first porous electrode, dense electrolyte and the second porous electrode on the exterior surface of the porous support tube 2. This pre-firing of the porous support tube 2 may be carried out at elevated temperatures, such as about 1050° C., for 2 hours in hydrogen or argon. Pre-firing of the porous support tube 2 at this temperature and time provides sufficient strength and robustness to place the successive active layers on the outside of porous support tube 2 but does not produce any substantial dimensional change in the porous support tube 2.

Referring to FIG. 6 a layer of a first porous anode 3 is placed on the outer surface of pre-fired porous support tube 2. The same anode materials, methods of applying the anode layer, and the coating application step used in the internal design may be used for applying anode 3 to the exterior surface of the first porous support tube 2.

Electrolyte layer 4 is next placed on porous anode 3 and for this the same materials, methods of applying the electrolyte layer and coating application step used in the internal design may be used for applying the electrolyte layer 4 to the anode layer 3.

Next a cathode layer 5 is then placed on the electrolyte layer 4 and again as in the internal design the same materials, methods of applying the cathode layer 5 and coating application step used in the internal design may be used for applying the cathode layer 5 to the electrolyte layer 4.

At this stage of the fabrication of the solid oxide fuel cell 1 the sub-assembly comprising the pre-fired porous support tube 2 with the applied anode layer 3, electrolyte layer 4, and cathode layer 5 may be preferably sintered at an elevated temperature, such as for example 1300° C. preferably for 2 hours in hydrogen or argon. The sintering temperature and sintering time for the sub-assembly are selected to be the same as the final sintering temperature and sintering time for the assembled solid oxide fuel cell 1. By undergoing this sintering operation the porous support tube 2 will undergo minimal or no shrinkage during the final sintering of the assembled solid oxide fuel cell 1.

Next, tubular member 6 is prepared separately. For this, tubular member 6 may be pre-fired to an elevated temperature that imparts sufficient strength and robustness to facilitate placement of tubular member 6 on the outside of the sintered sub-assembly. This pre-firing of the tubular member 6 may be carried out at elevated temperatures, such as about 1050° C., for 2 hours in hydrogen or argon. Pre-firing of the tubular member 6 at this temperature and time provides sufficient strength and robustness to facilitate its placement on the outside of the sintered sub-assembly but does not produce any substantial dimensional change in tubular member 6 and still permits a final sintering of the assembled solid oxide fuel cell 1.

Again, It is important for the successful practice of the present invention that in embodiments shown in FIGS. 6-10 that the pre-fired porous sintered tubular member 6 is sized properly for safe placement of tubular member 6 on the outside of the sintered sub-assembly to prevent damage or scarring of the outer most electrode of the sub-assembled support tube 2. It is expected that a porous tubular member 6 formed using water-atomized 434L stainless steel powder having a particle size of 38-45 microns and having a wall thickness of 1000 μm will undergo a shrinkage of about 20% when sintered at 1300° C. for about 2 hours in hydrogen or argon.

Lastly, the assembled solid oxide fuel cell 1 is given a final sintering at an elevated temperature of preferably 1300° C. for about 2 hours in hydrogen or argon to form the final solid oxide fuel cell 1 product. Since the porous support tube 2 has already been sintered to this elevated temperature, it will undergo minimal or no shrinkage during the final sintering of the assembled solid oxide fuel cell, permitting the tubular member 6 which has been pre-fired to a lower temperature of about 1050° C., as discussed above, to shrink onto cathode layer 5, thus permitting a tight electrical connection between the tubular member 6 and cathode 5 along the length of the solid oxide fuel cell 1. Those skilled in the art will recognize this sintering technique to be a constrained sintering process. Further, conducting this final sintering of the assembled solid oxide fuel cell 1 at 1300° C. for about 2 hours in hydrogen or argon ensures that the final solid oxide fuel cell product has sufficient porosity to permit oxygen, water or hydrogen to penetrate the pores of sintered support tube 2 and tubular member 6.

Additionally, carrying out the final sintering of the assembly solid oxide fuel cell 1 at sintering at 1300° C. for about 2 hours in hydrogen or argon results in a porous anode layer 3, a dense electrolyte layer 4, and a porous cathode layer 5. For this, it has been found that sintering at 1300° C. preferably for 2 hours in hydrogen or argon is sufficient to produce anode and cathode layers having a porosity of preferably about 35% while providing the electrolyte layer with a density above 90% of theoretical, preferably above about 95% of theoretical.

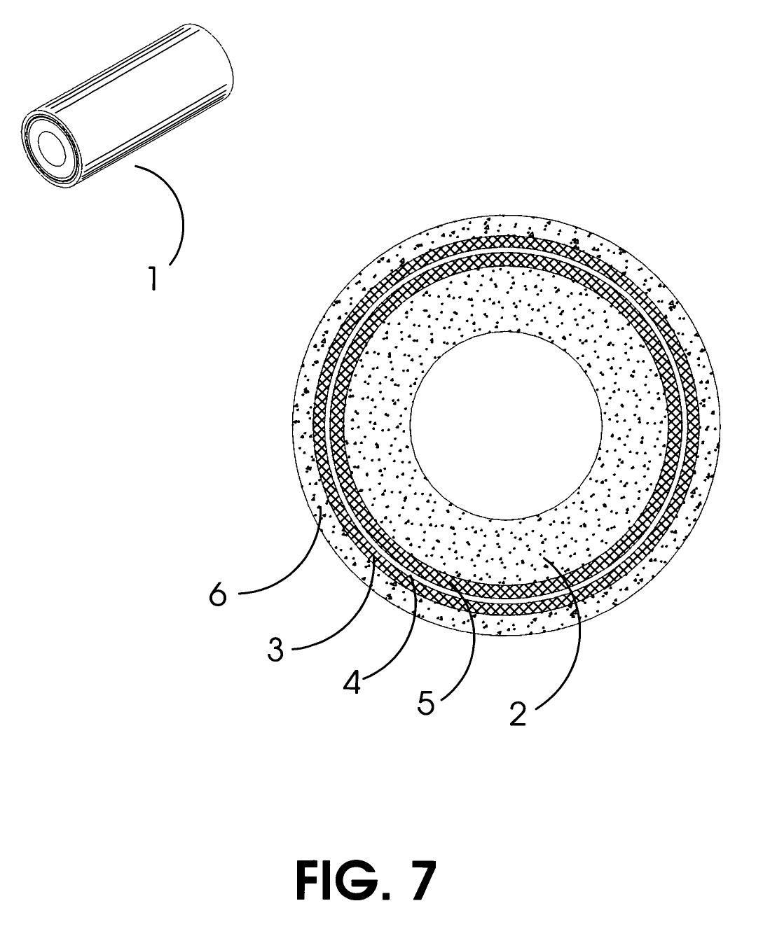

In an alternate refinement as shown in FIG. 7 the successive layers may be reversed, e.g., a first porous cathode layer 5 being disposed radially on the exterior surface of the first porous support tube 2 followed by, successively, a dense electrolyte layer 4 and then a second porous anode layer 3.

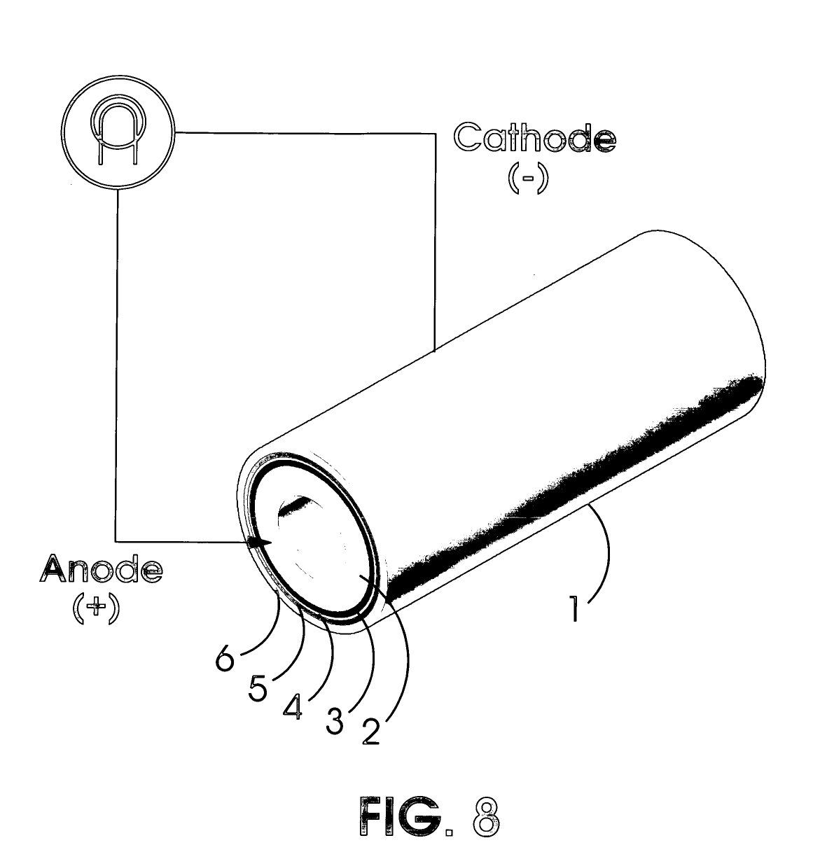

FIG. 8 is a schematic showing the bi-tubular solid oxide fuel cell 1 of the present invention wherein the successive outer layers are shown being disposed radially on the exterior surface of the first porous support tube 2 and comprising a first porous electrode comprising an anode 3, a dense electrolyte 4 and a second porous electrode comprising a cathode 5, and a second porous, sintered tubular member 6 formed, deposited, or placed in electrical contact with the porous cathode 5 in a power generation mode. In this mode, the electrons transport through the anode 3 to the external circuit and back to the cathode 5, providing a source of useful electrical power in an external circuit. For a SOFC operating at 800° C. a typical operating current is 325 mA/cm² at 0.75 volt and power density of 250 mW/cm².

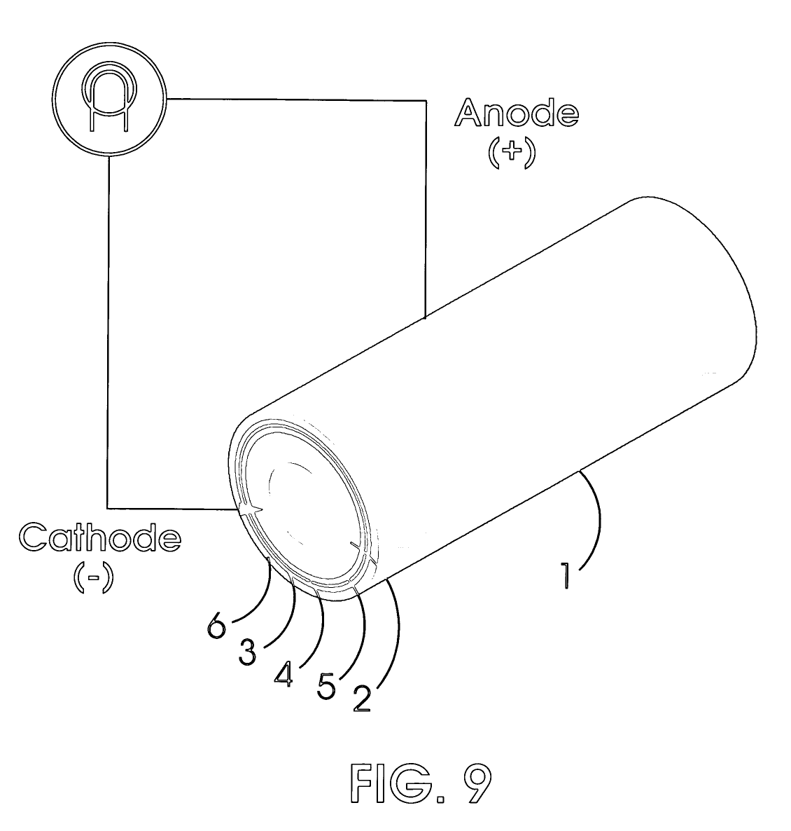

FIG. 9 is a schematic showing the preferred bi-tubular solid oxide fuel cell 1 of the present invention wherein the successive outer layers are shown being disposed radially on the exterior surface of the first porous support tube 2 and comprising a first porous electrode comprising a cathode 5, a dense electrolyte 4 and a second porous electrode comprising an anode 3, and a second porous, sintered tubular member 6 placed in electrical contact with the porous anode 3 in a power generation mode. In this mode, the electrons transport through the anode 3 to the external circuit and back to the cathode 5, providing a source of useful electrical power in an external circuit. For a SOFC operating at 800° C. a typical operating current is 325 mA/cm² at 0.75 volt and power density of 250 mW/cm².

In accordance with another aspect of the present invention a solid oxide fuel cell may be operated in the electrolysis mode, consuming electrical power and process heat while producing hydrogen. Those skilled in the art will appreciate that in operation, a solid oxide electrolyzer is the opposite of the solid oxide fuel cell, i.e., electrolyzer cell produces hydrogen using electric power, whereas the fuel cell consumes hydrogen producing electric power.

Fuel cells operating in the electrolysis mode have been demonstrated for tubular systems. For a general discussion on tubular solid oxide electrolyzer cells see the journal article by N. J. Maskalick, “High Temperature Electrolysis Cell Performance Characteristic,” Int. J Hydrogen Energy, pp. 563-570, 1986, the disclosure of which is incorporated herein by reference. Also, see article by J. E. O'Brien, et al, “Performance Measurements of Solid-Oxide Electrolysis Cells for Hydrogen Production,” Journal of Fuel Cell Science and Technology, Vol. 2, August 2005, pp. 156-163, the disclosure of which is incorporated herein by reference.

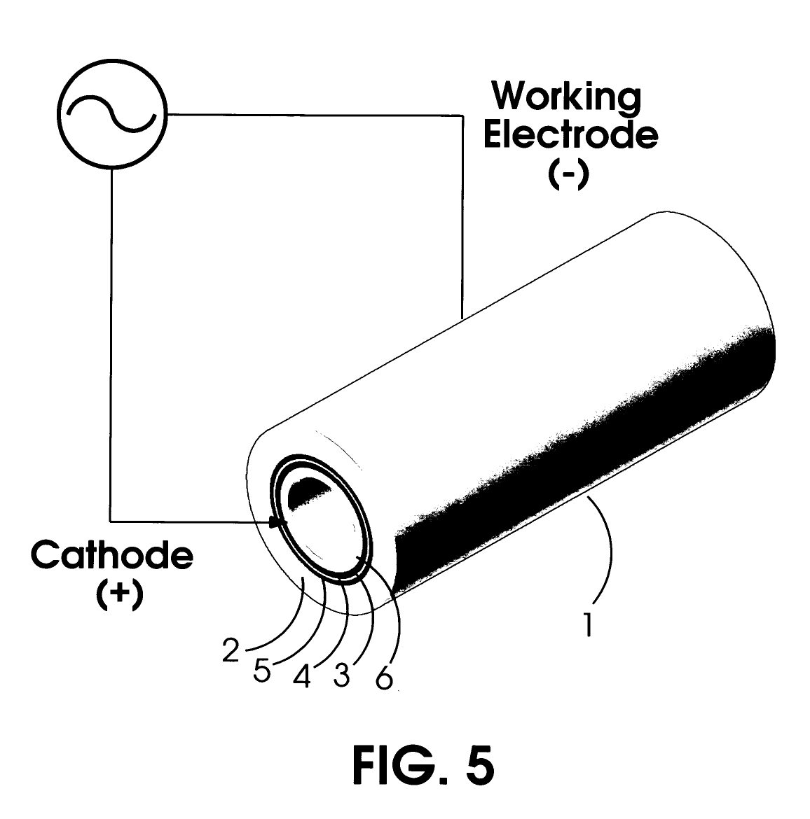

Beneficially, it has been found that the same unique bi-tubular configuration and materials of construction for a solid oxide fuel cell may be used for a solid oxide electrolyzer cell. It will be appreciated that the two electrodes for the electrolyzer cell are referred to as the working electrode (anode) and the cathode. For this, the solid oxide electrolyzer cell 1 may, as shown in FIG. 5, be comprised of a first porous support tube 2 having successive layers of a first porous working electrode (anode) 3 where hydrogen is produced, a dense electrolyte 4, and a second porous electrode comprising a cathode 5, disposed radially on the interior surface of the first porous support tube 2 and a second porous tubular member 6 which is formed, deposited, or placed in electrical contact with the second porous electrode comprising the cathode 5 in a hydrogen generation mode. Means for applying an electropotential force across the working electrode (anode) (−) and the cathode (+), such as a battery is shown.

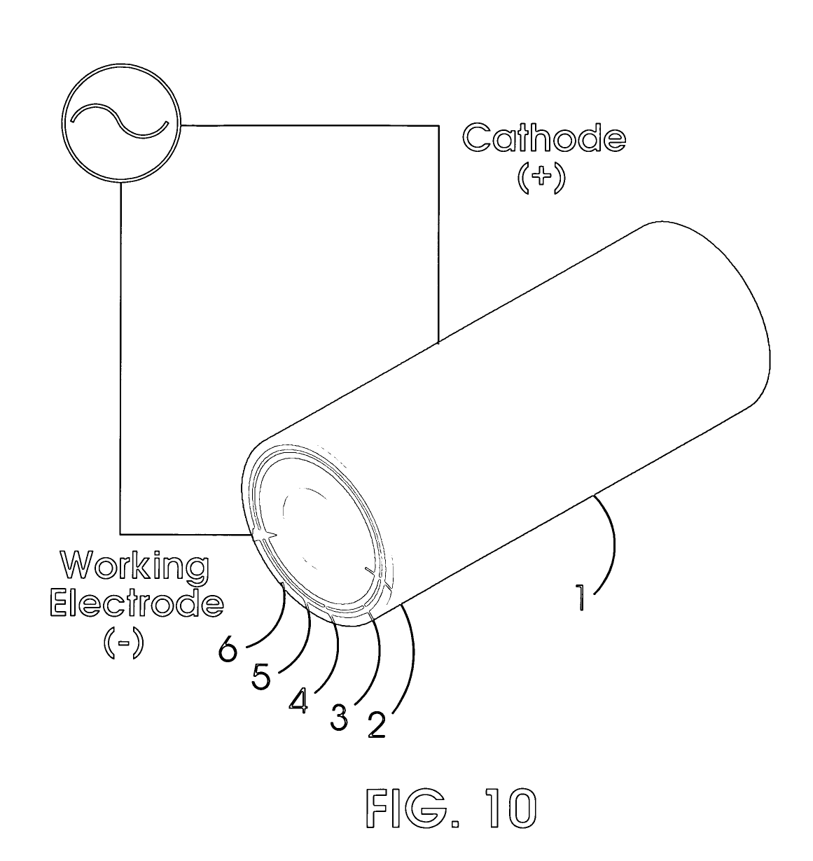

A further refinement of the present invention as a solid oxide electrolyzer cell 1 is shown in FIG. 10. There the solid oxide electrolyzer cell 1 may be comprised of a first porous support tube 2 having successive layers of a first porous working electrode (anode) 3 where hydrogen is produced, a dense electrolyte 4, and a second porous electrode comprising a cathode 5, disposed radially on the exterior surface of the first porous support tube 2 and a second porous tubular member 6 which is formed, deposited, or placed in electrical contact with the second porous electrode comprising the cathode 5 in a hydrogen generation mode. Means for applying an electropotential force across the working electrode (anode) (−) and the cathode (+), such as a battery is shown.

It is known that for solid oxide electrolyzer cells, the amount of energy which has to be provided as electricity decreases as the temperature increases. For example, bi-tubular solid oxide electrolyzer cells of the present invention operating at a temperature in the range of 800° to 900° would require 1.0-1.1 watt/cm² to produce 400-425 standard cm³/min. of hydrogen gas. A typical SOEC of the present invention would, for example, operate at current densities of 0.1 amphere/cm² and 1.0 volt/cell. This corresponds to 325 kW/mole H₂/sec. Theoretically, without any loses due to area specific resistance, a SOEC would require 187 kW/mole H₂/sec electrical energy and 248 kW/mole H₂/sec electrical plus thermal energy.

This makes the solid oxide electrolyzer cell particularly attractive when coupled with a high temperature steam source such as in a nuclear power plant, such as the Gen IV nuclear reactor.

Similarly, as for the solid oxide fuel cell, in an alternate refinement of the present invention for a solid oxide electrolyzer cell, the successive layers may be reversed, i.e., a first porous electrode comprising a cathode layer 5 disposed radially on the interior surface of the first porous support tube 2, followed by, successively, a dense electrolyte layer 4 and then a second porous electrode comprising a working electrode (anode) layer 3.

In terms of operating temperature, unlike the solid oxide fuel cell (SOFC) the solid oxide electrolyzer cell (SOEC) efficiency increases with increasing temperature. Both the SOFC and the SOEC use and produce electricity with less than 100% efficiency. The waste heat generated in this manner offsets the heat required to preheat the steam in the case of the SOEC or the hydrogen and oxygen in the case of the SOFC. In the case of the SOFC around 200% excess air may be used so the size of the cathode chamber is very large compared to that of the SOEC. The size of the anode chamber is comparable.

It is known in the prior art that a solid oxide electrolyzer cell may be constructed using the same commonly used materials for solid oxide fuel cells. For example, Ni-yttria-stabilized zirconia (YSZ) may be used for the anode; yttria-stabilized zirconia (YSZ) for the electrolyte and strontium doped lanthanum manganite material may be used as the cathode material with the preferred cathode material being La₈Sr₂MnO₃ (LSM).

In either embodiment, oxygen, water or hydrogen must be able to penetrate the porous metal tube(s) and the porous electrode layer(s) so the porosity, tortuosity, and permeability required for either the SOFC or the SOEC are the same. As note above for a SOFC, a suitable range of porosities for support tube is 40%-60%, and preferably 50%-60%. Similarly, suitable porosities for the porous anode and cathode layers may be in the range of 20%-50%, and preferably 30%-40%, and more preferably 35%.

Since a single solid oxide fuel cell provides a rather small open circuit voltage, on the order of about 1 volt, it is known in that fuel cell designs link together in series and in parallel many individual cells to form a “stack” to produce a more useful voltage and power output level. In such arrangements, the individual solid oxide fuel cells typically are arrayed in a fuel cell stack between two headers that channel the separate reactive fuel and oxidant gases to the exterior and interior surfaces of the fuel cell and provide for collection of the currents from the anode and cathode to generate power from the fuel stack. U.S. published patent application No. US2006/0228615, publication date of Oct. 12, 06 for “Stack Configuration for Tubular SOFC” describes one such stack configuration for tubular solid oxide fuel cells. The present bi-tubular solid oxide fuel cell may, advantageously, offer improvements in the prior art current collection designs by the use of the inner and outer metallic tubes as the anode and cathode current collector for each solid oxide fuel cell. The overall “stack” design using the bi-tubular SOFC elements of the present invention is quite simple and flexible. Further, fuel cell stacks using the bi-tubular solid oxide fuel cells of the present invention are easily scalable by either adding more cells or lengthening the cells in the stack to achieve particular power ratings.

What is claimed is:

1. A solid state electrochemical device comprising:
a. a first porous, sintered support tube consisting essentially of a material selected from the group consisting of a non-noble transition metal, a non-noble transition metal alloy and a cermet incorporating one or more of a non-noble transition metal and a non-noble transition metal alloy;
b. successive layers of a first porous electrode, a dense electrolyte and a second porous electrode, said successive layers disposed radially on the interior surface of said first porous, sintered support tube or disposed radially on the exterior surface of the first porous, sintered support tube; and
c. a second porous, sintered tubular member consisting essentially of a material selected from the group consisting of a non-noble transition metal, a non-noble transition metal alloy and a cermet incorporating one or more of a non-noble transition metal and a non-noble transition metal alloy formed, deposited, or placed in electrical contact with said second porous electrode.

2. The device of claim 1 wherein said first porous, sintered support tube is a metal selected from the group consisting of Series 300 and 400 stainless steel.

3. The device of claim 2 wherein said metal is 434L stainless steel.

4. The device of claim 3 wherein said first porous, sintered support tube has a porosity in the range of 40%-60%.

5. The device of claim 4 wherein said first porous, sintered support tube has a porosity in the range of 50%-60%.

6. The device of claim 5 wherein said first porous, sintered support tube has a diameter between 11-38 mm and a wall thickness of 500 μm to 1000 μm

7. The device of claim 1 wherein said first porous electrode is a porous anode layer comprising a material selected from the group consisting of nickel oxide and yttria-stabilized zirconia or nickel oxide and ceria or doped ceria, ceria or other suitable rare earth combined with a precious metal.

8. The device of claim 7 wherein said porous anode layer comprises Ni-yttria-stabilized zirconia.

9. The device of claim 8 wherein said porous anode layer has a thickness of from 5 μm to 50 μm.

10. The device of claim 1 wherein said dense electrolyte layer material is selected from the group consisting of yttria-stabilized zirconia, other rare earth oxide stabilized zirconia, or any other suitable ceramic oxygen ion conductor.

11. The device of claim 10 wherein said dense electrolyte layer is yttria-stabilized zirconia.

12. The device of claim 11 wherein said dense electrolyte layer has a thickness of from 2 μm to 100 μm.

13. The device of claim 12 wherein said dense electrolyte layer has a thickness from 2 μm to 50 μm.

14. The device of claim 1 wherein said second porous electrode is a porous cathode layer comprising a material selected from the group consisting of doped and undoped oxides or mixtures of oxides in the pervoskite family and other electronically conducting mixed rare earth oxides and mixtures of rare earth oxides and oxides of cobalt, nickel, copper, iron, chromium, manganese, and combinations of such oxides.

15. The device of claim 14 wherein said porous cathode layer is strontium doped lanthanum manganite.

16. The device of claim 14 wherein said porous cathode layer has a thickness of from 10 μm to 100 μm.

17. The device of claim 1 wherein said second porous, sintered tubular member is a metal selected from the group consisting of Series 300 and 400 stainless steel.

18. The device of claim 17 wherein said metal is 434L stainless steel.

19. The device of claim 18 wherein said first porous, sintered support tube has a porosity in the range of 40%-60%.

20. The device of claim 19 wherein said first porous, sintered support tube has a porosity in the range of 50%-60%.

21. The device of claim 20 wherein said first porous, sintered support tube has a wall thickness of 500 μm to 1000 μm.

22. A solid oxide fuel cell comprising:
a. a first porous, sintered support tube consisting essentially of a material selected from the group consisting of a non-noble transition metal, a non-noble transition metal alloy and a cermet incorporating one or more of a non-noble transition metal and a non-noble transition metal alloy;
b. successive layers of a first porous electrode, a dense electrolyte and a second porous electrode, said successive layers disposed radially on the interior surface of said first porous, sintered support tube or disposed radially on the exterior surface of the first porous, sintered support tube; and
c. a second porous, sintered tubular member consisting essentially of a material selected from the group consisting of a non-noble transition metal, a non-noble transition metal alloy and a cermet incorporating one or more of a non-noble transition metal and a non-noble transition metal alloy formed, deposited, or placed in electrical contact with said second porous electrode.

23. The solid oxide fuel cell of claim 22 wherein said porous, sintered support tube is a metal selected from the group consisting of Series 300 and 400 stainless steel.

24. The solid oxide fuel cell of claim 23 wherein said metal is 434L stainless steel.

25. The solid oxide fuel cell of claim 24 wherein said porous, sintered support tube has a porosity in the range of 40%-60%.

26. The solid oxide fuel cell of claim 25 wherein said porous, sintered support tube has a porosity in the range of 50%-60%.

27. The solid oxide fuel cell of claim 26 wherein said porous, sintered support tube has a diameter between 11-38 mm and a wall thickness of 500 μm to 1000 μm

28. The solid oxide fuel cell of claim 22 wherein said first porous electrode is a porous anode layer comprising a material selected from the group consisting of nickel oxide and yttria-stabilized zirconia or nickel oxide and ceria or doped ceria, ceria or other suitable rare earth combined with a precious metal.

29. The solid oxide fuel cell of claim 28 wherein said porous anode layer comprises Ni-yttria-stabilized zirconia.

30. The solid oxide fuel cell of claim 29 wherein said porous anode layer has a thickness of from 5 μm to 50 μm.

31. The solid oxide fuel cell of claim 22 wherein said dense electrolyte layer material is selected from the group consisting of yttria-stabilized zirconia, other rare earth oxide stabilized zirconia, or any other suitable ceramic oxygen ion conductor.

32. The solid oxide fuel cell of claim 31 wherein said dense electrolyte layer is yttria-stabilized zirconia.

33. The solid oxide fuel cell of claim 32 wherein said dense electrolyte layer has a thickness of from 2 μm to 100 μm.

34. The solid oxide fuel cell of claim 33 wherein said dense electrolyte layer has a thickness from 2 μm to 50 μm.

35. The solid oxide fuel cell of claim 22 wherein said second porous electrode is a porous cathode layer comprising a material selected from the group consisting of doped and undoped oxides or mixtures of oxides in the pervoskite family and other electronically conducting mixed rare earth oxides and mixtures of rare earth oxides and oxides of cobalt, nickel, copper, iron, chromium, manganese, and combinations of such oxides.

36. The solid oxide fuel cell of claim 35 wherein said porous cathode layer is strontium doped lanthanum manganite.

37. The solid oxide fuel cell of claim 36 wherein said porous cathode layer has a thickness of from 10 μm to 100 μm.

38. The solid oxide fuel cell of claim 22 wherein said second porous, sintered tubular member is a metal selected from the group consisting of Series 300 and 400 stainless steel.

39. The solid oxide fuel cell of claim 38 wherein said metal is 434L stainless steel.

40. The solid oxide fuel cell of claim 39 wherein said first porous, sintered support tube has a porosity in the range of 40%-60%.

41. The solid oxide fuel cell of claim 40 wherein said first porous, sintered support tube has a porosity in the range of 50%-60%.

42. The solid oxide fuel cell of claim 41 wherein said first porous, sintered support tube has a wall thickness of 500 μm to 1000 μm.

43. A solid oxide electrolyzer cell comprising:
a. a first porous, sintered support tube consisting essentially of a material selected from the group consisting of a non-noble transition metal, a non-noble transition metal alloy and a cermet incorporating one or more of a non-noble transition metal and a non-noble transition metal alloy;
b. successive layers of a first porous working anode, a dense electrolyte and a second porous cathode, said successive layers radially disposed on the interior surface of said first porous, sintered support tube or disposed radially on the exterior surface of the first porous, sintered support tube;
c. a second porous, sintered tubular member consisting essentially of a material selected from the group consisting of a non-noble transition metal, a non-noble transition metal alloy and a cermet incorporating one or more of a non-noble transition metal and a non-noble transition metal alloy formed, deposited, or placed in electrical contact with said second porous electrode; and
d. means for applying an electropotential force across the working anode and the cathode.
